(19) United States
(12) Patent Application Publication
(10) Pub. No.: US 2026/0017758 A1
(43) Pub. Date: Jan. 15, 2026

(54) CONTEXT AWARE HIGH-FIDELITY MASK GENERATION FOR FINEGRAIN OBJECT INSERTION AND LAYOUT CONTROL

(71) Applicant: ADOBE INC., SAN JOSE, CA (US)

(72) Inventors: Jianming Zhang, Cupertino, CA (US); Qing Liu, Santa Clara, CA (US); Cameron Younger Smith, San Jose, CA (US); Zhe Lin, Clyde Hill, WA (US); Jaskirat Singh, Canberra (AU)

(21) Appl. No.: 18/772,807

(22) Filed: Jul. 15, 2024

(51) Int. Cl. G06T 5/50; G06T 5/70; G06T 7/194; G06V 10/25

(52) U.S. Cl. CPC G06T 5/50; G06T 5/70; G06T 7/194; G06V 10/25; G06T 2207/20081; G06T 2207/20221

(57) ABSTRACT

A method, apparatus, non-transitory computer readable medium, and system for image processing include obtaining an input prompt and a layout mask, where the input prompt describes a first element and the layout mask includes a second element. A mask generation model generates an image mask based on the input prompt and the layout mask, wherein the image mask includes a first region corresponding to the first element and a second region corresponding to the second element. The mask is provided to an image generation model for generating a synthetic image, where the synthetic image depicts the first element in the first region and the second element in the second region.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on a conditioning.

In some cases, image generation includes the use of a machine learning model to generate a synthetic image based on a dataset. For example, the machine learning model is trained to generate a synthetic image based on a text, a color, a style, an image, or a mask. In some cases, the synthetic image depicts an element conditioned by the text, color, style, image, or mask.

### SUMMARY

Aspects of the present disclosure provide a method and system for image generation. In one aspect, the system receives an input image and a text prompt to generate a synthetic image. In one aspect, the text prompt includes an object prompt describing an object to be inserted into the input image and a text description describing the relation between the object and the background scene depicted by the input image. According to some aspects, the system includes a segmentation model configured to segment the input image to obtain a layout mask that represents an element depicted in the input image. The system includes a mask generation model trained to generate an image mask based on the layout mask, the object prompt, and the text description. In one aspect, the layout mask indicates a location and a shape of the object in the background scene. The system includes an image generation model configured to generate a synthetic image based on the layout mask.

A method, apparatus, non-transitory computer readable medium, and system for image processing include obtaining an input prompt and a layout mask, wherein the input prompt describes a first element and the layout mask includes a second element; generating, using a mask generation model, an image mask based on the input prompt and the layout mask, wherein the image mask includes a first region corresponding to the first element and a second region corresponding to the second element; and providing the image mask to an image generation model for generating a synthetic image, wherein the synthetic image depicts the first element in the first region and the second element in the second region.

A method, apparatus, non-transitory computer readable medium, and system for image processing include obtaining a training set including an input prompt, an input layout mask, and a ground-truth image mask, where the input prompt includes a first element, the input layout mask includes a second element, and the ground-truth image mask includes the first element and the second element and training, using the training set, a mask generation model to generate an image mask based on the input layout mask and the input prompt, where the image mask indicates a location of the first element and a location of the second element.

An apparatus and system for image processing include at least one processor, at least one memory storing instructions executable by the at least one processor, and a mask generation model comprising parameters stored in the at least one memory and trained to generate an image mask based on an input prompt and a layout mask, wherein the input prompt includes a first element, the layout mask includes a second element, and the image mask indicates a first region corresponding to the first element and a second region corresponding to the second element.

### BRIEF DESCRIPTION OF THE DRAWINGS

FIG. 1 shows an example of an image processing system according to aspects of the present disclosure.

FIG. 2 shows an example of a method for generating a synthetic image using an image mask according to aspects of the present disclosure.

FIG. 3 shows an example of image mask generation according to aspects of the present disclosure.

FIG. 4 shows an example of image generation based on fine-grain mask prediction according to aspects of the present disclosure.

FIG. 5 shows an example of mask generation based on a bounding mask according to aspects of the present disclosure.

FIG. 6 shows an example of image mask generation using composition planning according to aspects of the present disclosure.

FIG. 7 shows an example of image generation using composition planning according to aspects of the present disclosure.

FIG. 8 shows an example of a method for generating an image mask according to aspects of the present disclosure.

FIG. 9 shows an example of an image processing apparatus according to aspects of the present disclosure.

FIG. 10 shows an example of a machine learning model according to aspects of the present disclosure.

FIG. 11 shows an example of a mask generation model according to aspects of the present disclosure.

FIG. 12 shows an example of a method for image processing according to aspects of the present disclosure.

FIG. 13 shows an example of training a mask generation model according to aspects of the present disclosure.

FIG. 14 shows an example of a computing device according to aspects of the present disclosure.

### DETAILED DESCRIPTION

Aspects of the present disclosure provide a method and system for image generation. In one aspect, the system receives an input image and a text prompt to generate a synthetic image. In one aspect, the text prompt includes an object prompt describing an object to be inserted into the input image and a text description describing the relation between the object and the background scene depicted by the input image.

According to some aspects, the system includes a segmentation model configured to segment the input image to obtain a layout mask that represents an element depicted in the input image. The system includes a mask generation model trained to generate an image mask based on the layout mask, the object prompt, and the text description. In one aspect, the layout mask indicates a location and a shape of the object in the background scene. The system includes an image generation model configured to generate a synthetic image based on the layout mask.

A subfield in the image process refers to object inpainting based on a mask. In some cases, for example, a large-scale language-image (LLI) model may be used to perform multi-modal object inpainting and insertion. For example, controls over the inserted object details may be enhanced by using a combination of text-based conditioning (e.g., a text prompt) with additional guidance from a course bounding box or a user-scribble mask. In some cases, the text prompt may describe the object semantics, and the coarse mask provides control over the position and scale of the generated object.

However, the use of coarse masks for object insertion introduces one or more challenges. For example, the introduction of a coarse mask into an image generation model may inadvertently modify a portion of the background scene surrounding the inserted object. To minimize the background artifacts, conventional models use user-scribble-based free-form masks instead of bounding box inputs. However, the scribble-based mask may limit the generation of artifacts in scenarios for describing coarse objects (e.g., mountains, lakes, bears, etc.). Additionally, the generation of accurate free-form masks for a number of fine-grain features (e.g., human) may be challenging. In some cases, generating variations in the position and scale of the inserted object may require additional inputs.

In some cases, conventional image generation models use coarse bounding boxes or user scribble-based masks to indicate the location and scale of the object to be inpainted or inserted into an input image. However, background preservation around a region of the inserted object may be poor, as the conventional image generation models generate new features or pixels within the bounding box or the user scribble masks. In some cases, conventional models use image compositing techniques to provide various suggestions for target object placements. For example, the conventional models generate suggestions based on a cropped RGB object instance and the input image. However, conventional models are unable to provide various suggestions for target object placement based on text guidance (e.g., the text prompt).

Some conventional models use semantic segmentation maps to generate controllable image outputs based on the user-scribble masks. For example, a conventional model uses a cross-attention-based training-free technique for controlling the overall scene layout based on the user-scribble mask. For example, a conventional model uses a versatile ControlNet model to control the semantic layout on a more fine-grained level through an input semantic map. However, the ability to control the different fine-grained scene elements is limited.

Accordingly, the present disclosure describes a method and a system that generates an image mask that indicates a location and fine-grained shape of the object to be generated in a background scene of an input image based on an input prompt and the input image. In one aspect, a segmentation model is configured to segment the input image to obtain a layout mask comprising a plurality of object masks representing one or more elements depicted in the input image. By generating the layout mask, the machine learning model of the present disclosure learns the relation between each element from the input image and the object to be generated. Accordingly, the machine learning model can automatically generate diverse suggestions for object insertion at diverse positions and scales.

According to some aspects, a mask generation model is trained to generate the image mask based on the layout mask and the input prompt. For example, the input prompt includes an object prompt describing the object to be inserted, and a contextual description describing the relation between the object and the background scene of the input image. Accordingly, the mask generation model can generate the image mask indicating a location and a fine-grained shape of the object described by the object prompt in the background scene. In some aspects, an image generation model is configured to generate a synthetic image based on the image mask. In some cases, the background scene of the input image is preserved in the synthetic image.

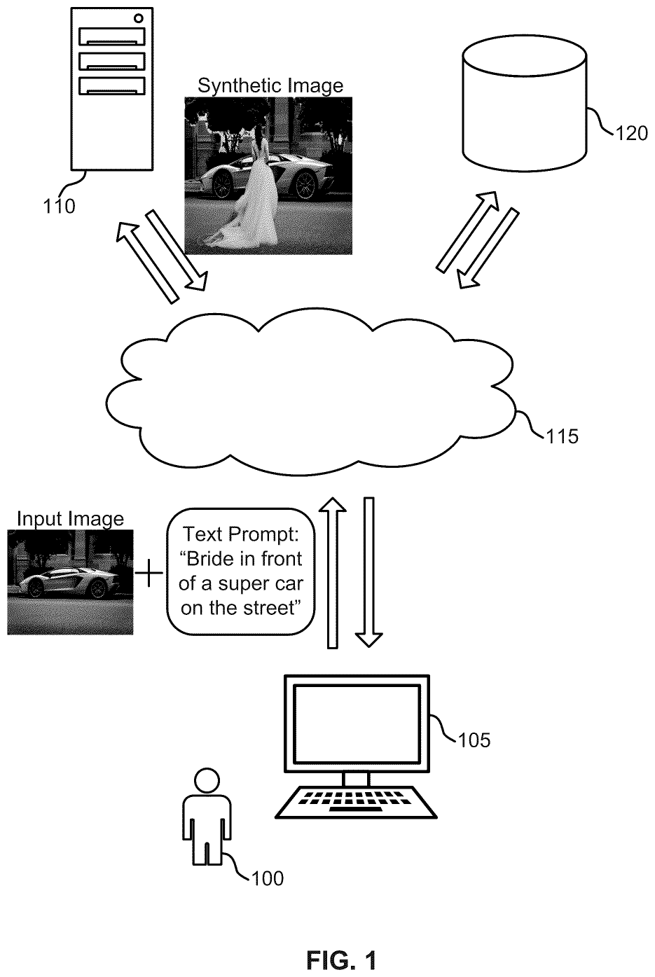

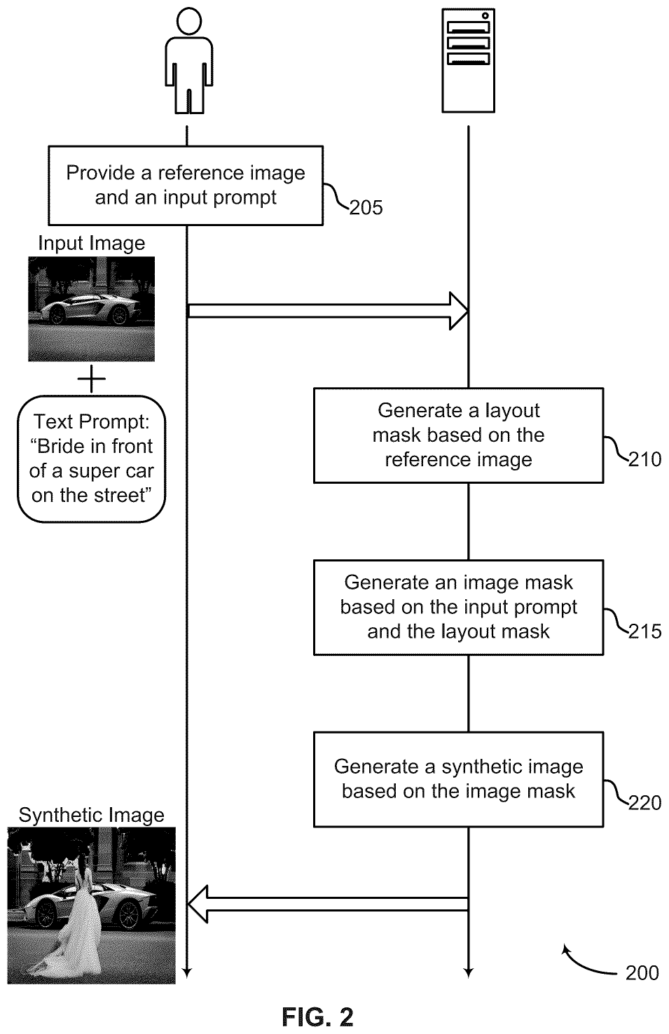

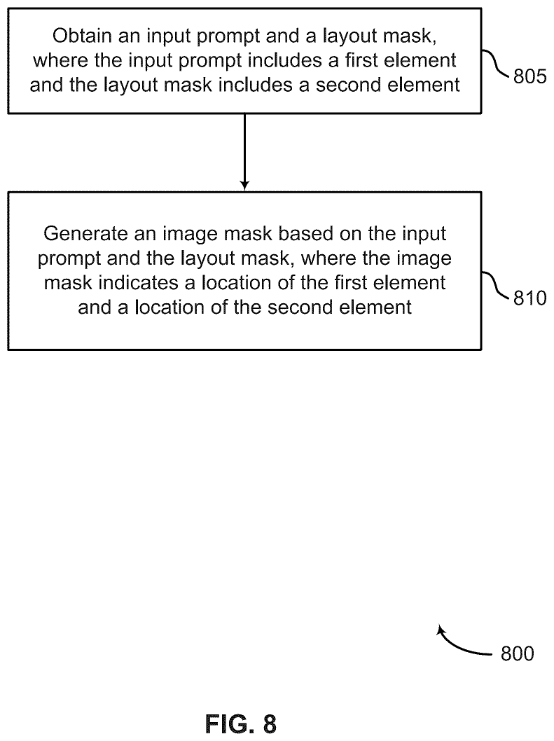

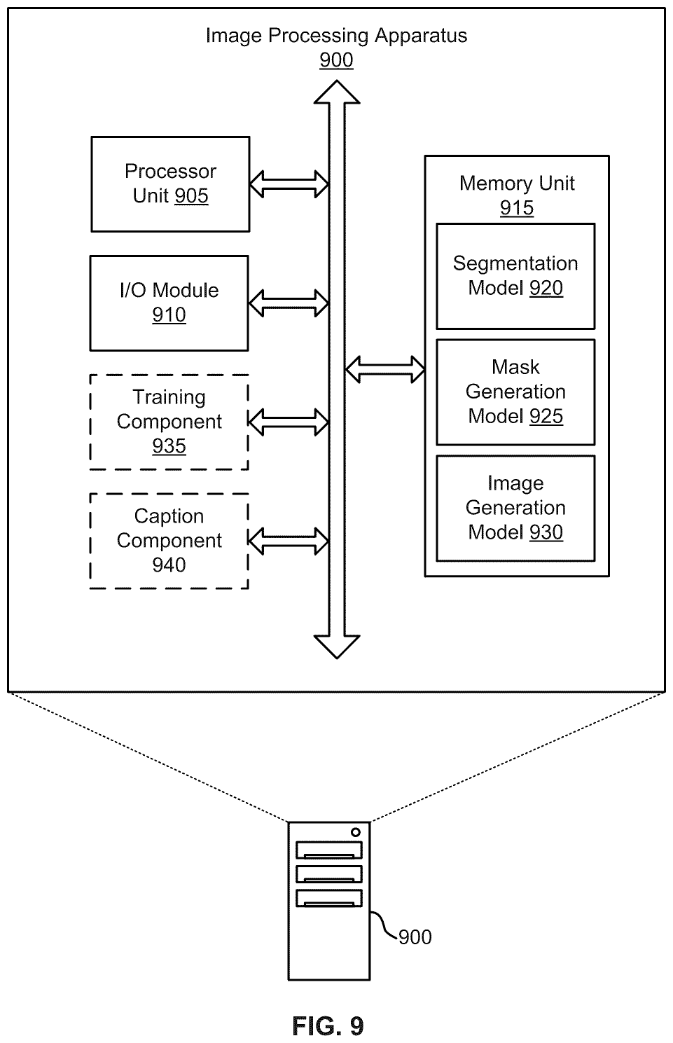

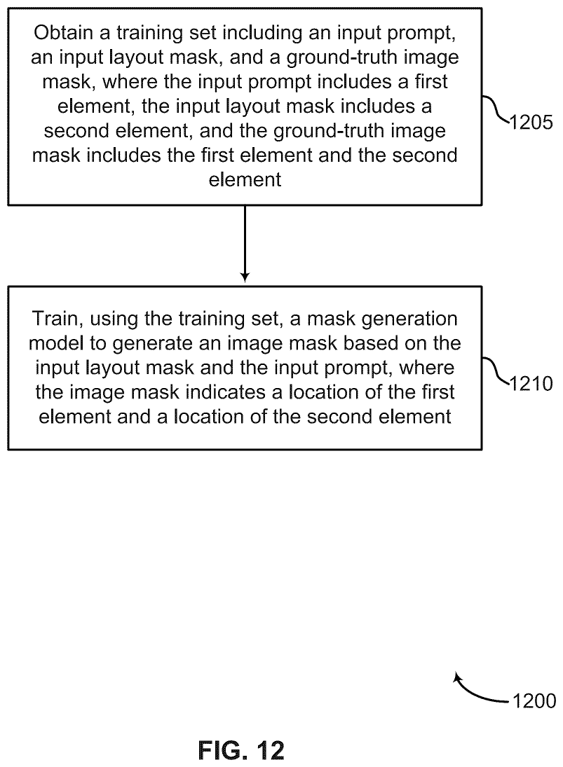

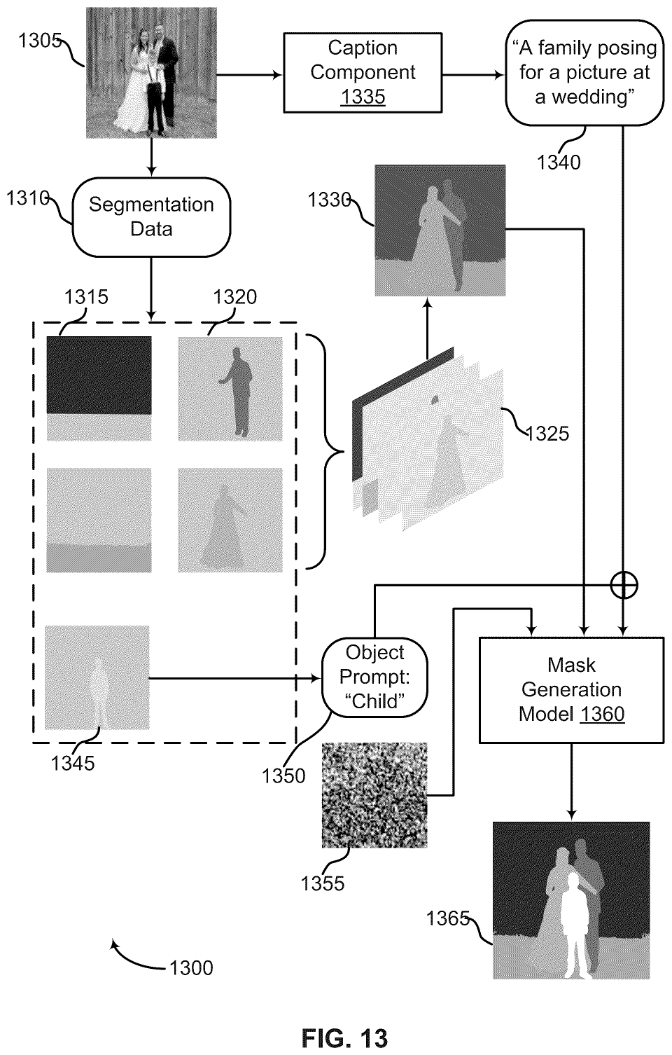

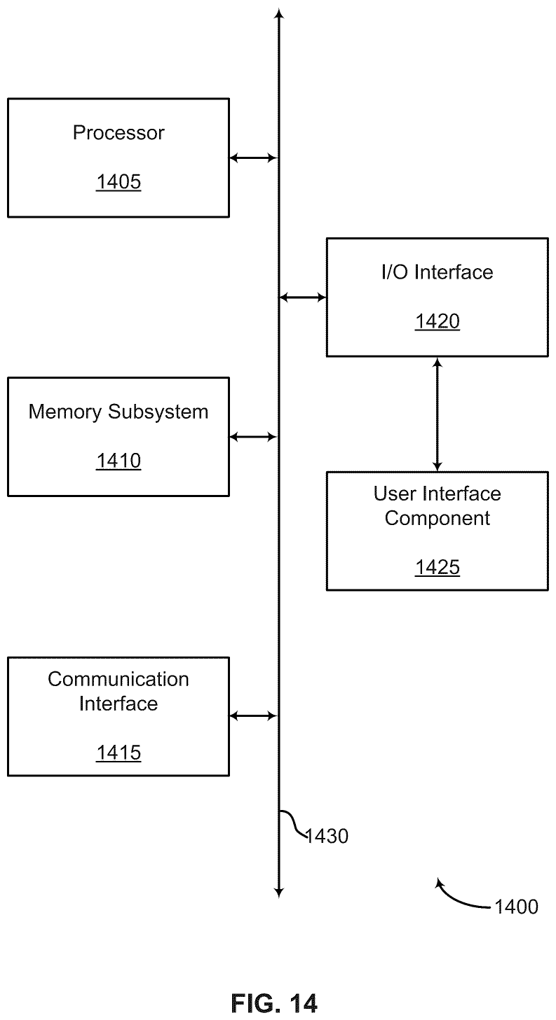

An example system of the inventive concept in image processing is provided with reference to FIGS. 1 and 14. An example application of the inventive concept in image processing is provided with reference to FIGS. 2-7. Details regarding the architecture of an image processing apparatus are provided with reference to FIGS. 9-11. An example of a process for image processing is provided with reference to FIG. 8. A description of an example training process is provided with reference to FIGS. 12-13.

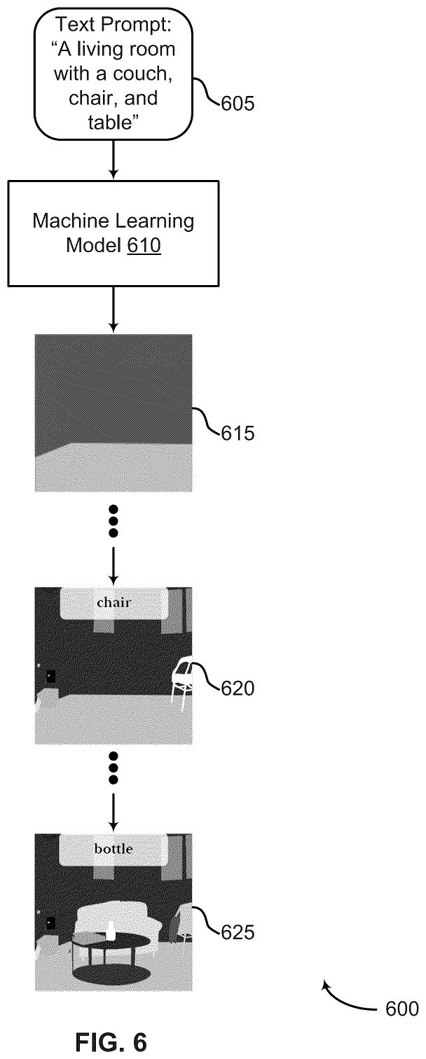

Embodiments of the present disclosure provide a system and a method that improve on conventional image generation models by accurately generating a fine-grained image mask representing an object to be generated. In some cases, a mask generation model is trained to receive a layout mask and an input prompt to generate an image mask that depicts the fine-grained shape and scale of the object. Accordingly, the background pixels (e.g., from the input image) surrounding the object in the synthetic image can be preserved. By generating the image mask using the layout mask, the mask generation model is able to accurately generate a mask prediction for the object in a natural location with respect to the background scene. By training the mask generation model using the layout mask (including one or more object masks layered into a layout mask), the mask generation model is able to iteratively generate detailed object masks in a semantic layout based on a layout description describing a scene (as described with reference to FIG. 6). Accordingly, the controllability of the layouts generated by the mask generation model can be enhanced. In some aspects, the synthetic image, generated based on the image mask, includes fewer or no artifacts.

### Image Generation

In FIGS. 1-8, a method, apparatus, non-transitory computer readable medium, and system for image processing include obtaining an input prompt and a layout mask, where the input prompt includes a first element and the layout mask includes a second element and generating, using a mask generation model, an image mask based on the input prompt and the layout mask, where the image mask indicates a location of the first element (i.e., a region occupied by the first element) and a location of the second element (i.e., a region occupied by the second element). The image mask can be used to generate a synthetic image, or for training another machine learning model (i.e., a segmentation model).

In some aspects, the first element comprises a foreground element and the second element comprises a background element. Some examples of the method, apparatus, non-transitory computer readable medium, and system further include obtaining a reference image. Some examples further include segmenting the reference image to obtain the layout mask.

Some examples of the method, apparatus, non-transitory computer readable medium, and system further include performing a diffusion process on the layout mask using the input prompt as guidance. In some aspects, the input prompt describes a relation between the first element and the second element.

Some examples of the method, apparatus, non-transitory computer readable medium, and system further include obtaining a bounding mask indicating a target region for the first element. In some cases, the image mask is generated based on the bounding mask and the location of the first element is within the target region.

In some aspects, the image mask includes a first layer indicating the location of the first element and a second layer indicating the location of the second element. In some aspects, the image mask includes a first color indicating the location of the first element and a second color indicating the location of the second element.

Some examples of the method, apparatus, non-transitory computer readable medium, and system further include generating, using the mask generation model, a subsequent image mask based on the image mask, wherein the subsequent image mask indicates a location of a third element.

Some examples of the method, apparatus, non-transitory computer readable medium, and system further include generating, using an image generation model, a synthetic image based on the image mask. In some aspects, the mask generation model is trained using a training set that includes an input layout mask and a ground-truth image mask.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 9.

Referring to FIG. 1, user 100 provides an input image and a text prompt to image processing apparatus 110 via user device 105 and cloud 115. In some cases, the text prompt describes an object to be added to the input image. For example, the input image depicts a car on the street. For example, the text prompt states “Bride in front of a super car on the street.” In some embodiments, image processing apparatus 110 includes a machine learning model that generates a mask representing the shape and location of the object to be added to the input image. For example, the machine learning model generates an image mask representing a bride in front of the car depicted in the input image. In some embodiments, the machine learning model performs inpainting based on the image mask to generate a synthetic image that depicts the bride described by the text prompt with the background scene of the input image. Image processing apparatus 110 displays the synthetic image to user 100 via user device 105 and cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 9. According to some aspects, image processing apparatus 110 includes a computer implemented network comprising a machine learning model, a segmentation model, a mask generation model, and an image generation model. Image processing apparatus 110 further includes a processor unit, a memory unit, an I/O module, a training component, and a caption component. In some embodiments, image processing apparatus 110 further includes a communication interface, user interface components, and a bus as described with reference to FIG. 14. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

According to some aspects, database 120 stores training data (or training set) including an input prompt, an input layout mask, and a ground-truth image mask. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for generating a synthetic image using an image mask according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a user (e.g., the user described with reference to FIG. 1) provides an input image (or sometimes referred to as a reference image) and a text prompt (or sometimes referred to as the input prompt) to the image processing apparatus (e.g., the image processing apparatus described with reference to FIGS. 1 and 9). For example, the input image depicts a car on the street. For example, the input prompt states “Bride in front of a super car on the street.” In some aspects, the image processing apparatus includes a segmentation model configured to generate a layout mask based on the input image. In some cases, the input prompt includes an object prompt and a contextual prompt. For example, the object prompt describes the object, e.g., bride. For example, the contextual prompt describes a relation between the object and elements of the input image, e.g., bride in front of a super car on the street. In some aspects, a mask generation model generates an image mask based on the layout mask, the object prompt, and the contextual prompt. In some cases, the image mask indicates a location and shape of the object in the context of the background scene in the input image. In some aspects, an image generation model is configured to generate a synthetic image based on the image mask.

At operation 205, the system provides a reference image and an input prompt. In some cases, the operations of this step refer to, or may be performed by, a user as described with reference to FIG. 1. For example, the user provides a reference image depicting a car on a street and an input prompt that states “Bride in front of a super car on the street” to image processing apparatus via a user interface provided by the image processing apparatus on a user device (e.g., the user device described with reference to FIG. 1). In some cases, the image process apparatus extracts an object prompt describing the object and a contextual prompt describing a relation between the object and the background scene of the input image based on the input prompt.

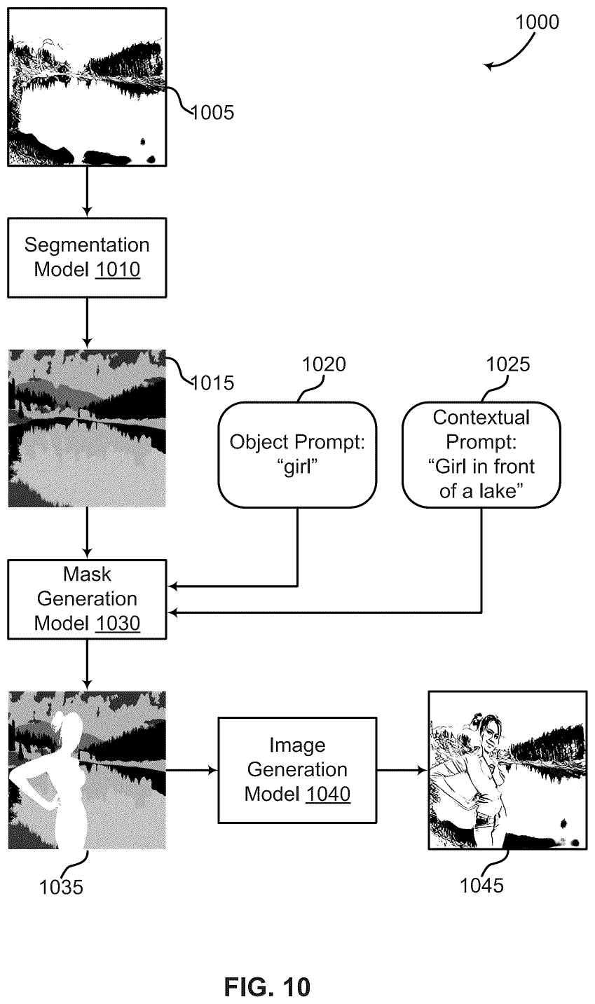

At operation 210, the system generates a layout mask based on the reference image. In some cases, the operations of this step refer to, or may be performed by, an image processing apparatus as described with reference to FIGS. 1 and 9. In some cases, the operations of this step refer to, or may be performed by, a segmentation model as described with reference to FIGS. 9 and 10. For example, the layout mask represents one or more elements depicted in the input image. In some embodiments, each pixel of the layout is labeled into an object category and an instance identification. Further detail on object category and instance identification is described with reference to FIG. 10.

In some embodiments, the layout mask comprises one or more entity masks representing the one or more elements depicted in the input image, respectively. In some embodiments, the layout mask includes one or more mask layers representing the one or more elements in corresponding layers depicted in the input image. In some embodiments, the layout mask includes one or more colors representing the one or more elements depicted in the input image, respectively.

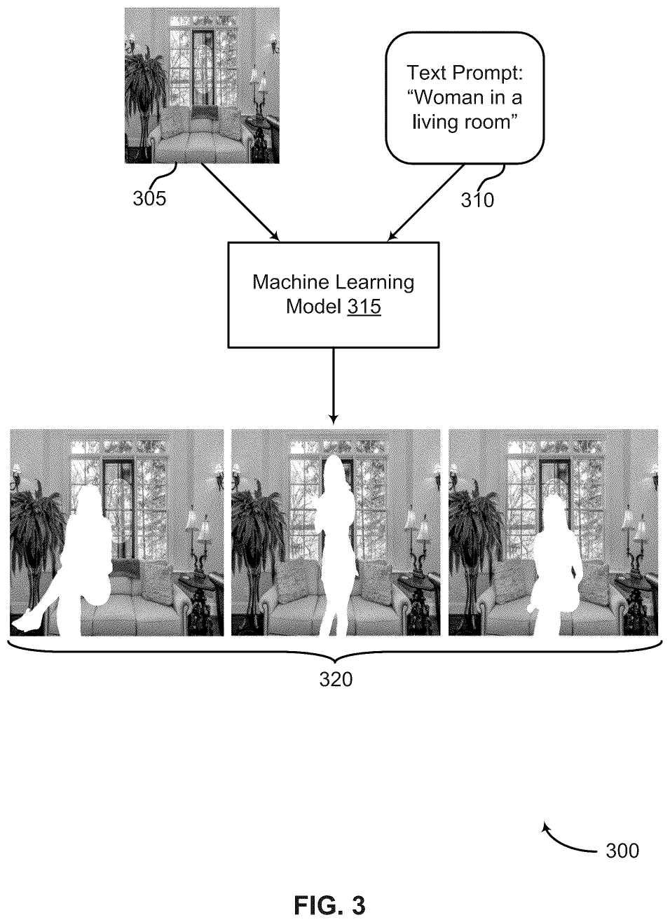

At operation 215, the system generates an image mask based on the input prompt and the layout mask. In some cases, the operations of this step refer to, or may be performed by, an image processing apparatus as described with reference to FIGS. 1 and 9. In some cases, the operations of this step refer to, or may be performed by, a mask generation model as described with reference to FIGS. 3, 9, 10, and 13. In some cases, for example, the mask generation model is trained to generate an image mask based on the layout mask, the object prompt, and the contextual prompt. For example, the image mask indicates a location and shape of the object in the background scene represented by the layout mask. In some cases, the image mask depicts a detailed outline mask representing the object to be generated.

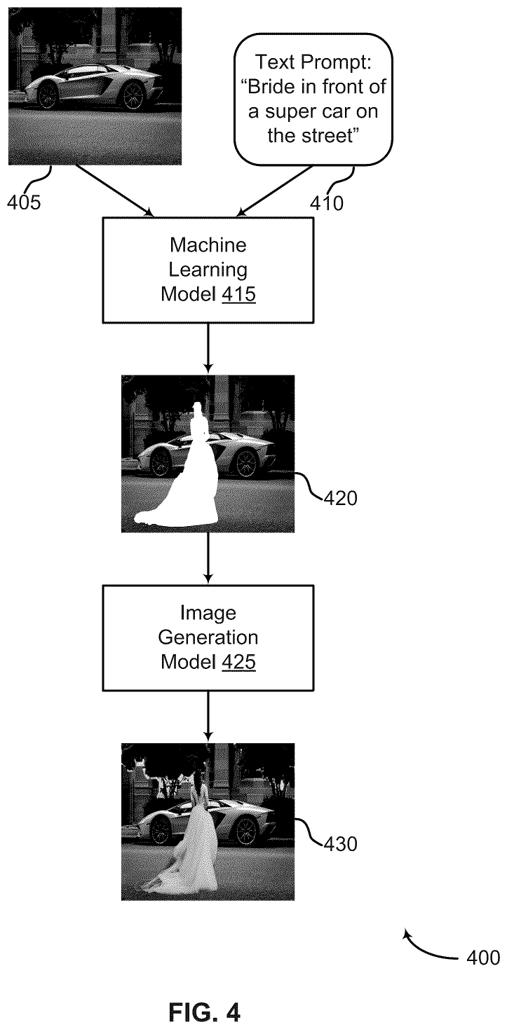

At operation 220, the system generates a synthetic image based on the image mask. In some cases, the operations of this step refer to, or may be performed by, an image processing apparatus as described with reference to FIGS. 1 and 9. In some cases, the operations of this step refer to, or may be performed by, an image generation model as described with reference to FIGS. 4, 7, 9, and 10. In some cases, for example, the image generation model generates the synthetic image based on the image mask. For example, the synthetic image depicts the bride standing in front of a super car on the street. Then, the synthetic image is displayed to the user via a user interface provided by the image processing apparatus on the user device.

FIG. 3 shows an example of image mask 320 generation according to aspects of the present disclosure. The example shown includes mask generation model 300, reference image 305, text prompt 310, machine learning model 315, and image mask 320.

Referring to FIG. 3, machine learning model 315 receives reference image 305 and text prompt 310 to generate image mask 320. For example, reference image 305 depicts a living room. For example, text prompt 310 states “Woman in a living room.” In some aspects, machine learning model 315 includes a segmentation model that segments reference image 305 to obtain a layout mask. For example, each pixel of the layout mask is assigned to a class label indicating the category of the element in reference image 305. For example, the layout mask provides a visual representation of the segmented elements. In some cases, the layout mask provides instance labels that distinguishes between different individual instances of the same category (e.g., a table, chair, etc.).

In some embodiments, machine learning model 315 extracts an object prompt describing the object to be generated and a contextual prompt describing a relation between the object and reference image 305 based on text prompt 310. For example, the object prompt states “woman” and the contextual description states “woman in a living room.” In some cases, the contextual description may be the same as text prompt 310. In some cases, contextual description may be different to text prompt 310. For example, contextual description may include additional detail that describe the relation between the object and the reference image 305. For example, contextual description may state “woman standing in a living room” or “woman sitting on a chair in a living room.” Accordingly, machine learning model 315 generates one or more image masks having a diverse option for object insertion at diverse positions and scales.

In some embodiments, machine learning model 315 includes a mask generation model trained to generate image mask 320 based on reference image 305 and text prompt 310. In some cases, image mask 320 includes a fine-grained shape and scale of the object to be generated. For example, image mask 320 on the left depicts a woman sitting on a chair in the living room with her legs crossing one another. For example, image mask 320 in the middle depicts a woman standing in the living room. For example, image mask 320 on the right depicts a woman sitting on the chair in the living room.

Mask generation model 300 is an example of, or includes aspects of, the corresponding element described with reference to FIGS. 9, 10, and 13. Reference image 305 is an example of, or includes aspects of, the corresponding element described with reference to FIGS. 4, 5, and 10. Text prompt 310 is an example of, or includes aspects of, the corresponding element described with reference to FIGS. 4-7, and 11.

Machine learning model 315 is an example of, or includes aspects of, the corresponding element described with reference to FIGS. 4-7, and 10. Image mask 320 is an example of, or includes aspects of, the corresponding element described with reference to FIGS. 4, 5, and 10.

FIG. 4 shows an example of image generation based on fine-grain mask prediction according to aspects of the present disclosure. The example shown includes image generation system 400, reference image 405, text prompt 410, machine learning model 415, image mask 420, image generation model 425, and synthetic image 430.

Referring to FIG. 4, machine learning model 415 receives reference image 405 and text prompt 410 to generate image mask 420. In an embodiment, image generation model 425 receives image mask 420 to generate synthetic image 430. For example, reference image 405 depicts a car on the street. For example, text prompt states “Bride in front of a super car on the street.” In some cases, image mask 420 depicts a fine-grained mask of a woman in the background scene of reference image 405.

In some embodiments, image generation model 425 is configured to generate synthetic image 430 based on image mask 420. For example, image generation model 425 may include a diffusion model, a diffusion-based inpainting model, a GAN-based inpainting model, patch-based inpainting model, or deep learning-based inpainting model. Since image mask 420 depicts a fine-grained mask of the object to be generated, new pixels are generated within the masked region. Accordingly, background of reference image 405 can be preserved in synthetic image 430.

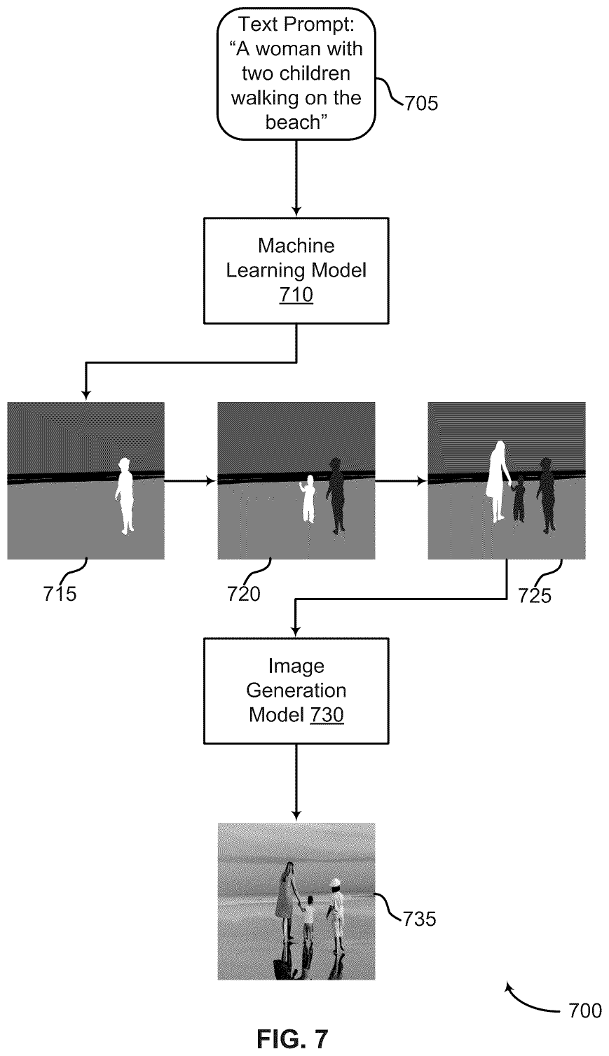

Image generation system 400 is an example of, or includes aspects of, the corresponding element described with reference to FIG. 7. Reference image 405 is an example of, or includes aspects of, the corresponding element described with reference to FIGS. 3, 5, and 10. Text prompt 410 is an example of, or includes aspects of, the corresponding element described with reference to FIGS. 3, 5-7, and 11.

Machine learning model 415 is an example of, or includes aspects of, the corresponding element described with reference to FIGS. 3, 5-7, and 10. Image mask 420 is an example of, or includes aspects of, the corresponding element described with reference to FIGS. 3, 5, and 10. Image generation model 425 is an example of, or includes aspects of, the corresponding element described with reference to FIGS. 7, 9, and 10. Synthetic image 430 is an example of, or includes aspects of, the corresponding element described with reference to FIGS. 7 and 10.

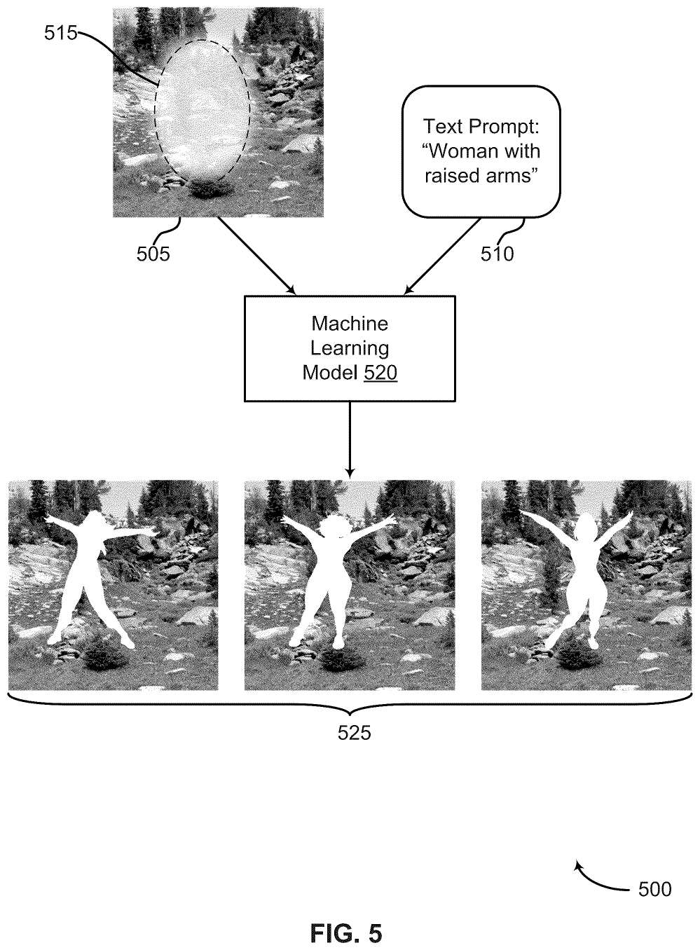

FIG. 5 shows an example of mask generation based on a bounding mask 515 according to aspects of the present disclosure. The example shown includes mask generation system 500, reference image 505, text prompt 510, bounding mask 515, machine learning model 520, and image mask 525.

Referring to FIG. 5, machine learning model 520 generates image mask 525 based on reference image 505, text prompt 510, and bounding mask 515. For example, an additional input such as bounding mask 515 is provided to machine learning model 520 to indicate a rough location and scale of the object to be generated. For example, bounding mask 515 includes a bounding box, a user scribble, a coarse location, or a combination thereof. In some cases, the bounding mask 515 is used as guidance to guide the mask generation process. Accordingly, machine learning model generates image mask 525 depicting a fine-grained shape and scale of the object in a region indicated by bounding mask 515.

Mask generation system 500 is an example of, or includes aspects of, the corresponding element described with reference to FIG. 6. Reference image 505 is an example of, or includes aspects of, the corresponding element described with reference to FIGS. 3, 4, and 10. Text prompt 510 is an example of, or includes aspects of, the corresponding element described with reference to FIGS. 3, 4, 6, 7, and 11.

Machine learning model 520 is an example of, or includes aspects of, the corresponding element described with reference to FIGS. 3, 4, 6, 7, and 10. Image mask 525 is an example of, or includes aspects of, the corresponding element described with reference to FIGS. 3, 4, and 10.

FIG. 6 shows an example of image mask generation using composition planning according to aspects of the present disclosure. The example shown includes mask generation system 600, text prompt 605, machine learning model 610, first image mask 615, second image mask 620, and third image mask 625.

Referring to FIG. 6, machine learning model 610 generates a plurality of image masks (e.g., first image mask 615, second image mask 620, and third image mask 625) based on text prompt 605. For example, text prompt 605 states “A living room with couch, chair, and table.” Machine learning model 610 generates a set of image masks, where each of the set of image masks represents an object to be generated. For example, first image mask 615 may be a general layout of the living room. Then, machine learning model 610 generates subsequent image masks each representing an item in the living room. For example, an image mask representing paintings hanging on the living room wall may be generated. For example, an image mask for decorations, electronics, sockets, electric cable, and socks may be respectively generated. In some cases, second image mask 620 includes a chair and the objects from previous image masks. Then, an image mask for cloth blanket, pillow, sofa, table, plane-surface, and book may be respectively generated. In some cases, third image mask 625 includes a bottle and the objects from previous image masks.

In some embodiments, the plurality of image masks are modified based on a user input. In some cases, an object can be added to a layer of the plurality of image masks. For example, a layer depicting a woman can be added after the third image mask 625. In some cases, an object can be removed from a layer of the plurality of image mask. For example, the layer depicting the couch may be removed. In some cases, an object can be modified at a layer of the plurality of image masks. For example, the shape of the couch can be modified. In some cases, a location of the object can be modified at a layer of the plurality of image masks. By generating a set of image masks in layers instead of generating a single image mask having the elements described by text prompt 605, the controllability of the layouts generated by machine learning model 610 can be enhanced.

Mask generation system 600 is an example of, or includes aspects of, the corresponding element described with reference to FIG. 5. Text prompt 605 is an example of, or includes aspects of, the corresponding element described with reference to FIGS. 3-5, 7, and 11. Machine learning model 610 is an example of, or includes aspects of, the corresponding element described with reference to FIGS. 3-5, 7, and 10.

First image mask 615 is an example of, or includes aspects of, the corresponding element described with reference to FIG. 7. Second image mask 620 is an example of, or includes aspects of, the corresponding element described with reference to FIG. 7. Third image mask 625 is an example of, or includes aspects of, the corresponding element described with reference to FIG. 7.

FIG. 7 shows an example of image generation using composition planning according to aspects of the present disclosure. The example shown includes image generation system 700, text prompt 705, machine learning model 710, first image mask 715, second image mask 720, third image mask 725, image generation model 730, and synthetic image 735.

Referring to FIG. 7, machine learning model 710 receives text prompt 705 that states “A woman with two children walking on the beach” to generate synthetic image 735. For example, machine learning model 710 generates first image mask 715 representing a first child on a background layout. Then, machine learning model 710 generates second image mask 720 representing the first child and a second child on the background layout. Then, machine learning model 710 generates third image mask 725 representing the first child, the second child, and a woman on the background layout. In some embodiments, image generation model receives third image mask 725 to generate synthetic image 735 depicting a woman with two children on the beach. In some cases, by generating the synthetic image based on the layered image masks, image generation model 730 can generate synthetic image having fewer or no artifacts.

Image generation system 700 is an example of, or includes aspects of, the corresponding element described with reference to FIG. 4. Text prompt 705 is an example of, or includes aspects of, the corresponding element described with reference to FIGS. 3-6, and 11. Machine learning model 710 is an example of, or includes aspects of, the corresponding element described with reference to FIGS. 3-6, and 10. First image mask 715 is an example of, or includes aspects of, the corresponding element described with reference to FIG. 6.

Second image mask 720 is an example of, or includes aspects of, the corresponding element described with reference to FIG. 6. Third image mask 725 is an example of, or includes aspects of, the corresponding element described with reference to FIG. 6. Image generation model 730 is an example of, or includes aspects of, the corresponding element described with reference to FIGS. 4, 9, and 10. Synthetic image 735 is an example of, or includes aspects of, the corresponding element described with reference to FIGS. 4 and 10.

FIG. 8 shows an example of a method 800 for generating an image mask according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains an input prompt and a layout mask, where the input prompt includes a first element and the layout mask includes a second element. In some cases, the operations of this step refer to, or may be performed by, a mask generation model as described with reference to FIGS. 3, 9, 10, and 13. In some cases, the input prompt describes an object to be generated in a synthetic image and a contextual description describing a relation between the object and a reference image. In some cases, the contextual description includes additional detail that describes the relation between the object and the reference image.

In some cases, the layout mask represents one or more elements depicted in the reference image. In some cases, the layout mask comprises one or more entity masks representing the one or more elements depicted in the reference image, respectively. In some embodiments, the layout mask includes one or more mask layers representing the one or more elements in corresponding layers depicted in the reference image. In some embodiments, the layout mask includes one or more colors representing the one or more elements depicted in the reference image, respectively

At operation 810, the system generates, using a mask generation model, an image mask based on the input prompt and the layout mask, where the image mask indicates the location of the first element and the location of the second element. In some cases, the operations of this step refer to, or may be performed by, a mask generation model as described with reference to FIGS. 3, 9, 10, and 13. In some cases, for example, the mask generation model generates the image mask depicting a fine-grained shape and location of the object based on the layout mask, the object prompt, and the contextual description. In some cases, the image mask depicts the object mask on the reference image. In some cases, the image mask depicts the object mask on the layout mask.

In some cases, the image mask comprises one or more entity masks representing the one or more elements depicted in the reference image, respectively, and an object mask representing the object to be generated. In some cases, the image mask includes one or more mask layers representing the one or more elements in corresponding layers depicted in the reference image and the object to be generated. In some cases, the image mask includes one or more colors representing the one or more elements depicted in the input image, respectively. In some cases, the image mask includes a white-colored mask representing the object to be generated.

In some cases, a foreground element is an object to be generated. For example, the foreground element may be a person, a chair, a dog, a bike, a tree, etc. In some cases, a background element is a scene or a component of a scene that occupies the backdrop or surrounds the foreground element. For example, the background element may be a lake, a mountain, a living room, a yard, etc.

### System Architecture

In 9-11 and 14, an apparatus and system for image processing include at least one processor, at least one memory storing instructions executable by the at least one processor, and a mask generation model comprising parameters stored in the at least one memory and trained to generate an image mask based on an input prompt and a layout mask, where the input prompt includes a first element, the layout mask includes a second element, and the image mask indicates a location of the first element and a location of the second element.

Some examples of the apparatus and system further include a segmentation model configured to segment a reference image to obtain the layout mask. Some examples of the apparatus and system further include an image generation model configured to generate a synthetic image based on the image mask. In some aspects, the mask generation model comprises a diffusion model.

FIG. 9 shows an example of an image processing apparatus 900 according to aspects of the present disclosure. The example shown includes image processing apparatus 900, processor unit 905, I/O module 910, memory unit 915, and training component 935. In one aspect, memory unit 915 includes segmentation model 920, mask generation model 925, and image generation model 930.

According to some embodiments of the present disclosure, image processing apparatus 900 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 900 is an example of, or includes aspects of, the corresponding element described with reference to FIG. 1.

Processor unit 905 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 905 is configured to operate a memory array using a memory controller. In other cases, a memory controller is integrated into the processor. In some cases, processor unit 905 is configured to execute computer-readable instructions stored in a memory to perform various functions. In some embodiments, processor unit 905 includes special-purpose components for modem processing, baseband processing, digital signal processing, or transmission processing. Processor unit 905 is an example of, or includes aspects of, the processor described with reference to FIG. 14.

I/O module 910 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 910 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 910 is an example of, or includes aspects of, the I/O interface described with reference to FIG. 14.

Examples of memory unit 915 include random access memory (RAM), read-only memory (ROM), or a hard disk. Examples of memory unit 915 include solid-state memory and a hard disk drive. In some examples, memory unit 915 is used to store computer-readable, computer-executable software including instructions that, when executed, cause a processor to perform various functions described herein.

In some cases, memory unit 915 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 915 store information in the form of a logical state.

In one aspect, memory unit 915 includes segmentation model 920, mask generation model 925, and image generation model 930. In one aspect, memory unit 915 includes a machine learning model, where the machine learning model includes segmentation model 920, mask generation model 925, and image generation model 930. Memory unit 915 is an example of, or includes aspects of, the memory subsystem described with reference to FIG. 14.

In some cases, a machine learning model is a computational algorithm, model, or system designed to recognize patterns, make predictions, or perform a specific task (for example, image processing) without being explicitly programmed. According to some aspects, the machine learning model is implemented as software stored in memory unit 915 and executable by processor unit 905, as firmware, as one or more hardware circuits, or as a combination thereof.

According to some embodiments of the present disclosure, the machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behaviors and characteristics of the machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model in which representations of the input interact with each other to determine attention weights for the input. Self-attention can be distinguished from other attention models because the attention weights are determined at least in part by the input itself.

According to some aspects, segmentation model 920 is implemented as software stored in memory unit 915 and executable by processor unit 905, as firmware, as one or more hardware circuits, or as a combination thereof. According to some aspects, segmentation model 920 obtains a reference image. In some examples, segmentation model 920 segments the reference image to obtain the layout mask.

According to some aspects, segmentation model 920 segments a training image to obtain the ground-truth image mask. In some examples, segmentation model 920 removes the first element from the ground-truth image mask to obtain the input layout mask. According to some aspects, segmentation model 920 is configured to segment a reference image to obtain the layout mask. Segmentation model 920 is an example of, or includes aspects of, the corresponding element described with reference to FIG. 10.

According to some aspects, mask generation model 925 is implemented as software stored in memory unit 915 and executable by processor unit 905, as firmware, as one or more hardware circuits, or as a combination thereof. According to some aspects, mask generation model 925 obtains an input prompt and a layout mask, where the input prompt includes a first element and the layout mask includes a second element. In some examples, mask generation model 925 generates an image mask based on the input prompt and the layout mask, where the image mask indicates a location of the first element and a location of the second element. In some aspects, the first element includes a foreground element and the second element includes a background element.

In some examples, mask generation model 925 performs a diffusion process on the layout mask using the input prompt as guidance. In some aspects, the input prompt describes a relation between the first element and the second element. In some examples, mask generation model 925 obtains a bounding mask indicating a target region for the first element, where the image mask is generated based on the bounding mask and the location of the first element is within the target region. In some aspects, the image mask includes a first layer indicating the location of the first element and a second layer indicating the location of the second element. In some aspects, the image mask includes a first color indicating the location of the first element and a second color indicating the location of the second element.

In some examples, mask generation model 925 generates a subsequent image mask based on the image mask, where the subsequent image mask indicates a location of a third element. In some aspects, the mask generation model 925 is trained using a training set that includes an input layout mask and a ground-truth image mask.

According to some aspects, mask generation model 925 comprises parameters stored in the at least one memory and trained to generate an image mask based on an input prompt and a layout mask, where the input prompt includes a first element, the layout mask includes a second element, and the image mask indicates a location of the first element and a location of the second element. In some aspects, the mask generation model 925 includes a diffusion model. Mask generation model 925 is an example of, or includes aspects of, the corresponding element described with reference to FIGS. 3, 10, and 13.

According to some aspects, image generation model 930 is implemented as software stored in memory unit 915 and executable by processor unit 905, as firmware, as one or more hardware circuits, or as a combination thereof. According to some aspects, image generation model 930 generates a synthetic image based on the image mask. According to some aspects, image generation model 930 is configured to generate a synthetic image based on the image mask. In one aspect, image generation model 930 includes a diffusion model. Image generation model 930 is an example of, or includes aspects of, the corresponding element described with reference to FIGS. 4, 7, and 10.

According to some aspects, training component 935 is implemented as software stored in memory unit 915 and executable by processor unit 905, as firmware, as one or more hardware circuits, or as a combination thereof. According to some embodiments, training component 935 is implemented as software stored in a memory unit and executable by a processor in the processor unit of a separate computing device, as firmware in the separate computing device, as one or more hardware circuits of the separate computing device, or as a combination thereof. In some examples, training component 935 is part of another apparatus other than image processing apparatus 900 and communicates with the image processing apparatus 900. In some examples, training component 935 is part of image processing apparatus 900.

According to some aspects, training component 935 obtains a training set including an input prompt, an input layout mask, and a ground-truth image mask, where the input prompt includes a first element, the input layout mask includes a second element, and the ground-truth image mask includes the first element and the second element. In some examples, training component 935 trains, using the training set, a mask generation model 925 to generate an image mask based on the input layout mask and the input prompt, where the image mask indicates a location of the first element and a location of the second element.

In some examples, training component 935 computes a diffusion loss based on the ground-truth image mask. In some examples, training component 935 updates parameters of the mask generation model 925 based on the diffusion loss. In some examples, training component 935 initializes the mask generation model 925 based on a pre-trained image generation model.

According to some aspects, caption component 940 is implemented as software stored in memory unit 915 and executable by processor unit 905, as firmware, as one or more hardware circuits, or as a combination thereof. According to some embodiments, caption component 940 is implemented as software stored in a memory unit and executable by a processor in the processor unit of a separate computing device, as firmware in the separate computing device, as one or more hardware circuits of the separate computing device, or as a combination thereof. In some examples, caption component 940 is part of another apparatus other than image processing apparatus 900 and communicates with the image processing apparatus 900. In some examples, caption component 940 is part of image processing apparatus 900. In some cases, for example, training component 935 includes caption component 940.

According to some aspects, caption component 940 generates the input prompt based on the training image. According to some aspects, caption component 940 includes natural language processing (NLP). NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models that make soft, probabilistic decisions based on attaching real-valued weights to input features. In some cases, these models express the relative probability of multiple answers. Caption component 940 is an example of, or includes aspects of, the corresponding element described with reference to FIG. 13.

FIG. 10 shows an example of a machine learning model 1000 according to aspects of the present disclosure. The example shown includes machine learning model 1000, reference image 1005, segmentation model 1010, layout mask 1015, object prompt 1020, contextual prompt 1025, mask generation model 1030, image mask 1035, image generation model 1040, and synthetic image 1045.

Referring to FIG. 10, machine learning model 1000 receives reference image 1005, object prompt 1020, and contextual prompt 1025 to generate synthetic image 1045. For example, machine learning model 1000 includes segmentation model 1010 configured to generate layout mask 1015 based on reference image 1005. For example, reference image 1005 depicts a scene of a lake. In some cases, layout mask 1015 includes a plurality of entity masks representing one or more elements depicted in reference image 1005, respectively. In some cases, each pixel in layout mask 1015 is labeled into an object category and instance identification. In some cases, the object category refers to the semantic category described below. In some cases, instance identification refers to the object instance described below.

In some aspects, segmentation model 1010 includes a semantic segmentation model. For example, the semantic segmentation model partitions an image (e.g., reference image 1005) into multiple segments or regions, where each segment is labeled with a semantic category. In some cases, semantic segmentation assigns a label to each pixel of the image. Accordingly, the semantic segmentation model provides data on the content of the image at the pixel level.

In some aspects, segmentation model 1010 includes an instance segmentation model. For example, the instance segmentation model labels each pixel with a semantic category and distinguishes individual object instances within each semantic category. In some cases, objects of the same class are segmented separately and uniquely identified. For example, when an image depicts two cars, the instance segmentation model labels the pixels of each car separately and assigns a unique identification (ID) to differentiate the two cars. In some cases, the instance segmentation model delineates the boundaries of individual object instances, even when two object instances are close together or partially occluded.

In some aspects, segmentation model 1010 includes a panoptic segmentation model. For example, the panoptic segmentation model labels each pixel of the image with a semantic category and instance ID. In some cases, the semantic labels represent stuff classes or thing classes. In some cases, the panoptic segmentation model simultaneously segments all pixels of the image into the semantic category (e.g., stuff classes) and identifies object instances (e.g., thing classes). For example, stuff classes include background elements such as sky road, grass, mountain, lake, etc. For example, thing classes include foreground elements such as a person, car, bicycle, etc.

In some embodiments, mask generation model 1030 receives layout mask 1015, object prompt 1020, and contextual prompt 1025 to generate image mask 1035. In some cases, for example, object prompt 1020 and contextual prompt 1025 are obtained from an input prompt. For example, the input prompt may state “Girl in front of a lake.” In some cases, machine learning model 1000 extracts object prompt 1020 which states “girl” from the input prompt. For example, object prompt 1020 describes the entity or object to be generated in synthetic image 1045. In some cases, contextual prompt 1025 describes a relation between object prompt 1020 and reference image 1005. In some cases, image mask 1035 includes a fine-grained shape and location of the object described by object prompt 1020 in layout mask 1015. For example, image mask 1035 depicts a mask of a woman (represented by the white region) in front of the lake (represented by the remaining region of the layout mask 1015).

In some embodiments, image generation model 1040 receives image mask 1035 to generate synthetic image 1045. For example, image generation model 1040 inpaints the white region of image mask 1035 by generating new pixels in the white region. For example, pixels depicting a woman are generated in synthetic image 1045. In some cases, the remaining region of the background scene is preserved in synthetic image 1045.

In some aspects, image generation model 1040 includes a patch-based inpainting model. For example, the patch-based inpainting model searches similar patches in the surrounding image area and uses the patches to reconstruct the missing region (or the white region of image mask 1035). In some cases, the patch-based inpainting model uses texture synthesis and exemplar-based inpainting.

In some aspects, image generation model 1040 includes a deep-learning-based inpainting model. For example, the deep-learning-based inpainting model inpaints a missing region of the image based on convolutional neural networks (CNNs). In some cases, a deep-learning-based inpainting model is trained on large datasets of images with missing regions and learns to generate realistic content for inpainting.

In some aspects, image generation model 1040 includes a diffusion-based inpainting model. For example, the diffusion-based inpainting model simulates the propagation of information or image features from surrounding areas into the missing regions. In some cases, the diffusion-based inpainting model is guided by additional guidance input, such as image mask 1035. In some cases, the inpainted regions align with the surrounding image context. For example, the diffusion process can be further guided by a text conditioning from a text guidance, such as object prompt 1020 and contextual prompt 1025.

According to some embodiments, the input image I (or reference image 1005), object description T_{obj} (or object prompt 1020), and textual description Tₜₑₓₜᵤₐₗ (or contextual prompt 1025) are provided to machine learning model 1000 to generate a fine-grained mask M_{obj} (or image mask 1035) for a target object. In some cases, the fine-grained mask M_{obj} is used as an input to an inpainting model (e.g., a ControlNet inpainting model) to generate synthetic image 1045.

In some embodiments, segmentation model 1010 including a panoptic segmentation model generates a semantic layout map S₁ based on input image/(or reference image 1005), object description T_{obj} (or object prompt 1020), and textual description Tₜₑₓₜᵤₐₗ (or contextual prompt 1025). The semantic layout map S is used as an input to mask generation model 1030 (e.g., a trained diffusion model) to generate a prediction of the fine-grained mask M_{obj} for the target object:

$${M}_{obj} = {D}_{θ} ( {ℰ}_{ϕ} ( {S}_{I} ) , {T}_{obj} , {T}_{textual} ) , \qquad ( 1 )$$

where D represents the trained diffusion model.

According to some embodiments, machine learning model 1000 receives an additional input to guide the mask generation process. For example, mask generation model 1030 receives a guidance input G_{obj} along with the other inputs (e.g., reference image 1005, object prompt 1020, and contextual prompt 1025) to generate image mask 1035. In some cases, guidance input G_{obj} includes a bounding box, coarse scribble, user scribble, etc. In some cases, guidance input G_{obj} is an example of, or includes aspects of, the bounding mask described with reference to FIG. 5.

Machine learning model 1000 is an example of, or includes aspects of, the corresponding element described with reference to FIGS. 3-7. Reference image 1005 is an example of, or includes aspects of, the corresponding element described with reference to FIGS. 3-5. Segmentation model 1010 is an example of, or includes aspects of, the corresponding element described with reference to FIG. 9.

Mask generation model 1030 is an example of, or includes aspects of, the corresponding element described with reference to FIGS. 3, 9, and 13. Image mask 1035 is an example of, or includes aspects of, the corresponding element described with reference to FIGS. 3-5. Image generation model 1040 is an example of, or includes aspects of, the corresponding element described with reference to FIGS. 4, 7, and 9. Synthetic image 1045 is an example of, or includes aspects of, the corresponding element described with reference to FIGS. 4 and 7.

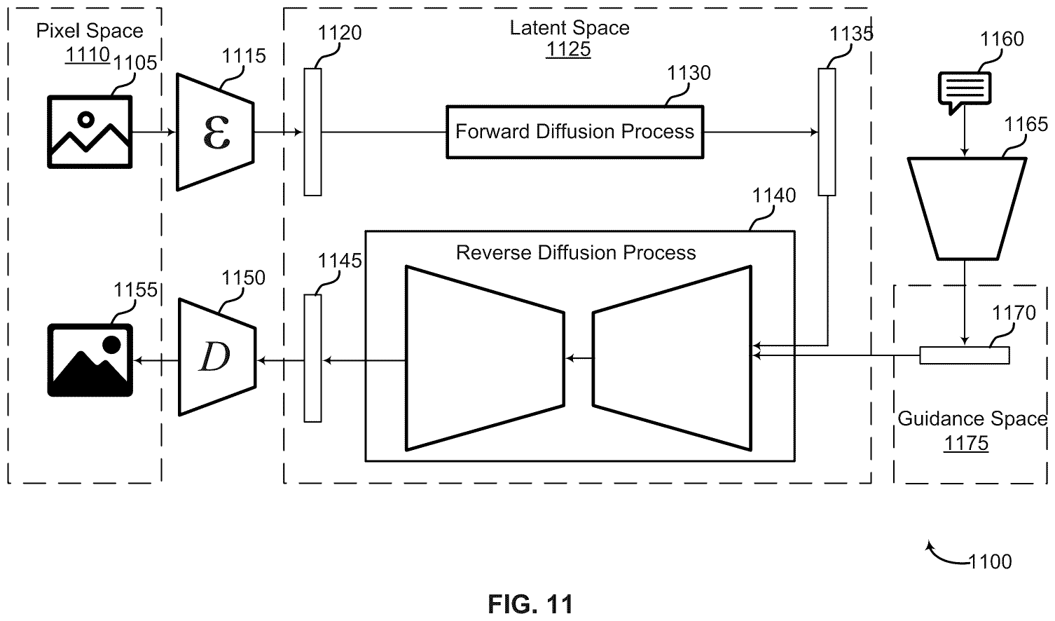

FIG. 11 shows an example of a mask generation model according to aspects of the present disclosure. The example shown includes diffusion model 1100, original image 1105, pixel space 1110, image encoder 1115, original image feature 1120, latent space 1125, forward diffusion process 1130, noisy feature 1135, reverse diffusion process 1140, denoised image feature 1145, image decoder 1150, output image 1155, text prompt 1160, text encoder 1165, guidance feature 1170, and guidance space 1175. In some embodiments, the mask generation model includes aspects of diffusion model 1100. In some aspects, the image generation model (described with reference to FIGS. 4, 7, 9, and 10) includes aspects of diffusion model 1100. Text prompt 1160 is an example of, or includes aspects of, the corresponding element described with reference to FIGS. 3-7.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 1100 may take an original image 1105 in a pixel space 1110 as input and apply an image encoder 1115 to convert original image 1105 into original image feature 1120 in a latent space 1125. Then, a forward diffusion process 1130 gradually adds noise to the original image feature 1120 to obtain noisy feature 1135 (also in latent space 1125) at various noise levels.

Next, a reverse diffusion process 1140 (e.g., a U-Net ANN) gradually removes the noise from the noisy feature 1135 at the various noise levels to obtain the denoised image features 1145 in latent space 1125. In some examples, denoised image feature 1145 is compared to the original image feature 1120 at each of the various noise levels, and parameters of the reverse diffusion process 1140 of the diffusion model are updated based on the comparison. Finally, an image decoder 1150 decodes the denoised image feature 1145 to obtain an output image 1155 in pixel space 1110. In some cases, an output image 1155 is created at each of the various noise levels. The output image 1155 can be compared to the original image 1105 to train the reverse diffusion process 1140. In some cases, output image 1155 refers to the synthetic image (e.g., described with reference to FIGS. 4, 7, and 10).

In some cases, image encoder 1115 and image decoder 1150 are pre-trained prior to training the reverse diffusion process 1140. In some examples, image encoder 1115 and image decoder 1150 are trained jointly, or the image encoder 1115 and image decoder 1150 are fine-tuned jointly with the reverse diffusion process 1140.

The reverse diffusion process 1140 can also be guided based on a text prompt 1160, or another guidance prompt, such as an image, a layout, a style, a color, a segmentation map, etc. The text prompt 1160 can be encoded using a text encoder 1165 (e.g., a multimodal encoder) to obtain guidance features 1170 in guidance space 1175. The guidance features 1170 can be combined with the noisy features 1135 at one or more layers of the reverse diffusion process 1140 to ensure that the output image 1155 includes content described by the text prompt 1160. For example, guidance feature 1170 can be combined with the noisy feature 1135 using a cross-attention block within the reverse diffusion process 1140.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having the same resolution and number of channels via a skip connection. These inputs are processed using a final neural network layer to produce output features. In some cases, the output features have the same resolution as the initial resolution and the same number of channels as the initial number of channels.

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features.

A diffusion process may also be modified based on conditional guidance. In some cases, a user provides a text prompt (e.g., text prompt 1160) describing content to be included in a generated image. In some examples, guidance can be provided in a form other than text, such as via an image, a sketch, a color, a style, or a layout. The system converts text prompt 1160 (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1100 generates an image based on the noise map and the conditional guidance vector.

A diffusion process can include both a forward diffusion process 1130 for adding noise to an image (e.g., original image 1105) or features (e.g., original image feature 1120) in a latent space 1125 and a reverse diffusion process 1140 for denoising the images (or features) to obtain a denoised image (e.g., output image 1155). The forward diffusion process 1130 can be represented as q(xₜ|xₜ₋₁), and the reverse diffusion process 1140 can be represented as p(xₜ₋₁|xₜ). In some cases, the forward diffusion process 1130 is used during training to generate images with successively greater noise, and a neural network is trained to perform the reverse diffusion process 1140 (e.g., to successively remove the noise).

In an example forward diffusion process 1130 for a latent diffusion model (e.g., diffusion model 1100), the diffusion model 1100 maps an observed variable x₀ (either in a pixel space 1110 or a latent space 1125) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1140. During the reverse diffusion process 1140, the diffusion model 1100 begins with noisy data x_{T}, such as a noisy image and denoises the data to obtain the p(xₜ₋₁|xₜ). At each step t−1, the reverse diffusion process 1140 takes xₜ, such as the first intermediate image, and t as input. Here, t represents a step in the sequence of transitions associated with different noise levels, The reverse diffusion process 1140 outputs xₜ₋₁, such as the second intermediate image iteratively until x_{T} is reverted back to x₀, the original image 1105. The reverse diffusion process 1140 can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 3 )$$

where p(x_{T})=N(x_{T}; 0, I) is the pure noise distribution as the reverse diffusion process 1140 takes the outcome of the forward diffusion process 1130, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space 1125 as input and a generated data \tilde{x} is mapped back into the pixel space 1110 from the latent space 1125 as output. In some examples, x₀ represents an original input image with low image quality, latent variables x₁, . . . , x_{T} represent noisy images, and \tilde{x} represents the generated image with high image quality.

A diffusion model 1100 may be trained using both a forward diffusion process 1130 and a reverse diffusion process 1140. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1130 in N stages. In some cases, the forward diffusion process 1130 is a fixed process where Gaussian noise is successively added to an image. In latent diffusion models, the Gaussian noise may be successively added to features (e.g., original image features 1120) in a latent space 1125.

At each stage n, starting with stage N, a reverse diffusion process 1140 is used to predict the image or image features at stage n−1. For example, the reverse diffusion process 1140 can predict the noise that was added by the forward diffusion process 1130, and the predicted noise can be removed from the image to obtain the predicted image. In some cases, an original image 1105 is predicted at each stage of the training process.

The training component (e.g., training component described with reference to FIG. 6) compares predicted image (or image features) at stage n−1 to an actual image (or image features), such as the image at stage n−1 or the original input image. For example, given observed data x, the diffusion model 1100 may be trained to minimize the variational upper bound of the negative log-likelihood-log pe (x) of the training data. The training component then updates parameters of the diffusion model 1100 based on the comparison. For example, parameters of a U-Net may be updated using gradient descent. Time-dependent parameters of the Gaussian transitions can also be learned.

### Training and Evaluation

In FIGS. 12-13, a method, apparatus, non-transitory computer readable medium, and system for image processing include obtaining a training set including an input prompt, an input layout mask, and a ground-truth image mask, where the input prompt includes a first element, the input layout mask includes a second element, and the ground-truth image mask includes the first element and the second element and training, using the training set, a mask generation model to generate an image mask based on the input layout mask and the input prompt, where the image mask indicates a location of the first element and a location of the second element.

Some examples of the method, apparatus, non-transitory computer readable medium, and system further include segmenting a training image to obtain the ground-truth image mask. Some examples further include removing the first element from the ground-truth image mask to obtain the input layout mask. Some examples of the method, apparatus, non-transitory computer readable medium, and system further include generating the input prompt based on the training image.

Some examples of the method, apparatus, non-transitory computer readable medium, and system further include computing a diffusion loss based on the ground-truth image mask. Some examples further include updating parameters of the mask generation model based on the diffusion loss. Some examples of the method, apparatus, non-transitory computer readable medium, and system further include initializing the mask generation model based on a pre-trained image generation model.

FIG. 12 shows an example of a method 1200 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains a training set including an input prompt, an input layout mask, and a ground-truth image mask, where the input prompt includes a first element, the input layout mask includes a second element, and the ground-truth image mask includes the first element and the second element. In some cases, the operations of this step refer to, or may be performed by, a training component as described with reference to FIG. 9. In some cases, for example, a large-scale dataset including fine-grain amodal segmentation masks for different objects in an input image is obtained. For example, the training dataset includes 32,785 diverse real-world images and 125,897 object instances across 500 different semantic classes (e.g., man, woman, tree, furniture, etc.). In some cases, the training image in the training set includes a variable number of object instances {A₁, A₂, . . . Aₙ}, n∈[2, 50]. In addition, the training image is annotated with an ordered sequence of semantic amodal segmentation maps {S₁, S₂, . . . . Sₙ}. In some cases, the training set includes a detailed description C₁ for the training image.

At operation 1210, the system trains, using the training set, a mask generation model to generate an image mask based on the input layout mask and the input prompt, where the image mask indicates a location of the first element and a location of the second element. In some cases, the operations of this step refer to, or may be performed by, a training component as described with reference to FIG. 9. In some cases, the mask generation model includes a Stable-Diffusion-v 1.5 model. In some cases, the mask generation model is trained for a total of 100 k iterations with a batch size of 192 and a learning rate of 1e-5. Further detail on training the mask generation model is described with reference to FIG. 13.

FIG. 13 shows an example of training a mask generation model 1360 according to aspects of the present disclosure. The example shown includes training system 1300, training image 1305, segmentation data 1310, first entity mask 1315, second entity mask 1320, layered masks 1325, training layout mask 1330, caption component 1335, training contextual prompt 1340, training object mask 1345, training object prompt 1350, noise latent 1355, mask generation model 1360, and prediction mask 1365.

Referring to FIG. 13, training system 1300 receives training image 1305 to generate prediction mask 1365. For example, a training component (e.g., the training component described with reference to FIG. 9) obtains training image 1305 depicting a family of three (e.g., man, woman, and child) at a wedding. In some cases, segmentation data 1310 is obtained from training image 1305. For example, segmentation data 1310 includes labeled data for each pixel in training image 1305. In some cases, segmentation data 1310 includes semantic category and instance ID for each element depicted in training image 1305. For example, based on training image 1305, segmentation data 1310 includes labeled data such as wall, meadow, man, woman, and child.

In some embodiments, the training component generates a plurality of entity masks based on segmentation data 1310. For example, the plurality of entity masks includes first entity mask 1315, second entity mask 1320, and training object mask 1345. For example, first entity mask 1315 represents the wall. For example, second entity mask 1320 represents the man. In some cases, for example, the training component generates a third entity mask representing the meadow and a fourth entity mask representing the woman. In some cases, a fifth entity mask representing the child is used as training object mask 1345. In some cases, each of the plurality of entity masks is represented in a different color. In some cases, each of the plurality of entity masks includes a precise shape and location of the element depicted in training image 1305.

In some embodiments, the training component combines the plurality of entity masks into layered masks 1325 to generate training layout mask 1330. For example, the layered masks 1325 includes a plurality of entity masks representing wall, meadow, man, and woman. In some cases, training layout mask 1330 includes and represents a wall, meadow, man, and woman from training image 1305. In some cases, training layout mask 1330 is used as input to mask generation model 1360.

In some embodiments, caption component 1335 generates training contextual prompt 1340 based on training image 1305. For example, training contextual prompt 1340 states “A family posing for a picture at a wedding.” For example, training contextual prompt 1340 describes the content of the visual features in training image 1305. In some cases, training contextual prompt 1340 is used as an input to mask generation model 1360.

In some cases, caption component 1335 includes NLP and generates descriptive captions (e.g., training contextual prompt 1340) based on images (e.g., training image 1305) or videos. In some cases, caption component 1335 processes an input image using a pre-trained convolutional neural network (CNN) such as ResNet, VGG, etc. The CNN extracts high-level features from the input image and captures visual information and semantic information. In some cases, the CNN outputs a high-dimensional feature vector that encodes the visual information of the input image. In some cases, for example, the feature vector is passed through a recurrent neural network (RNN), a transformer-based architecture, or a sequence generation model to generate the textual description or caption. In some cases, the caption aligns with the image features of the input image.

In some embodiments, the training component generates training object prompt 1350 based on training object mask 1345. For example, training object mask 1345 represents the child depicted in training image 1305. In some cases, training object prompt 1350 states “Child”. In some cases, training object prompt 1350 is concatenated with training contextual prompt 1340 and the combined prompt is used as input to mask generation model 1360.

In some embodiments, mask generation model 1360 performs a diffusion process to generate prediction mask 1365. For example, mask generation model 1360 takes training layout mask 1330 training contextual prompt 1340, training object prompt 1350, and noise latent 1355 as inputs to generate prediction mask 1365. In some cases, noise latent 1355 includes a combination of noise and visual features of training image 1305. In some cases, training layout mask 1330 is passed through an encoder to generate an encoded feature, where the encoded feature is in a semantic space. In some cases, the encoded feature from the training layout mask 1330 and the combined prompt from concatenating training contextual prompt 1340 and training object prompt 1350 are used as guidance to guide the diffusion process. Further detail on guiding the diffusion process is described with reference to FIG. 11.

According to some embodiments, the training process is performed in a semantic space. For example, during training, an image/(e.g., training image 1305) with a sequence of ordered amodal semantic instance maps {A₁, A₂, . . . Aₙ} and corresponding semantic object labels {O₁, O₂, . . . Oₙ} is obtained. Then, the training component can compute an intermediate layer semantic map as:

$${S}_{k} = {f}_{layer} ( \{ {A}_{1} , {A}_{2} , … {A}_{k} \} ) , where k ∈ [ 1 , n ] \qquad ( 4 )$$

where k is randomly chosen from [1, n] and f_{layer} is a layering operation that stacks the amodal semantic segmentation maps from i∈[1, k] in an ordered manner.

In some embodiments, the training component trains a diffusion-based mask prediction model D_{θ} (e.g., mask generation model 1360) which takes the intermediate layer semantic map Sₖ, the semantic description for next object T_{obj}←Oₖ₊₁, overall caption T_{context}←C₁ (for image I) as inputs to predict the binary mask {Aₖ₊₁} for the next object. In some cases, the intermediate layer semantic map Sₖ is passed through a learnable encoder ε_{ϕ} to obtain an encoded feature ε_{ϕ}(Sₖ). At a selected timestep t of the reverse diffusion process, the denoising noise prediction ∈ₜ is computed conditional jointly on previous noise latent Zₜ₋₁, and the model inputs {ε_{θ}(Sₖ), T_{obj}, T_{context}, t} as:

$${\tilde{ϵ}}_{pred} ( t ) = {U}_{θ} ( {Z}_{t - 1} , {ℰ}_{ϕ} ( {S}_{k} ) , {T}_{obj} , {T}_{context} , t ) , \qquad ( 5 )$$

where U_{θ} represents the U-Net of the diffusion model D. Further detail on U-Net is described with reference to FIG. 11.

In some cases, the diffusion model D is trained to predict the next layer Aₖ₊₁ using the following loss function:

$${ℒ}_{t} ( θ , ϕ ) = {𝔼}_{t \sim [ 1 , T ] , {S}_{k} , {A}_{k + 1} , {ϵ}_{t} [} {‖ {ϵ}_{t} - {\tilde{ϵ}}_{pred} ( t ) ‖}^{2} ] , \qquad ( 6 )$$

where T is the total number of reverse diffusion steps, ∈ₜ˜ [symbol] (0, I) is sampled from a normal distribution, and Aₖ₊₁ represents the ground-truth binary mask for the next object Oₖ₊₁.

According to some embodiments, the diffusion model (e.g., mask generation model 1360) is trained to perform object insertion at diverse positions and scales. In some embodiments, the diffusion model is trained to obtain direct control over the spatial location and details of the inserted object. Accordingly, the diffusion model can be trained using a train-time data augmentation method which enables a user to obtain additional control over the output prediction (e.g., prediction mask 1365). For example, using the intermediate layer semantic map Sₖ and the ground-truth mask Aₖ₊₁ for the next object, the input Sₖ may be replaced in the diffusion model as:

$${\tilde{S}}_{k} = g ( {S}_{k} , {G}_{obj} ) = {S}_{k} ⊙ ( 1 - α {G}_{obj} ) + α {G}_{obj} , \qquad ( 7 )$$

where G_{obj} represents the additional guidance input (e.g., bounding box mask or coarse scribbles described with reference to FIG. 5) provided by the user. In some cases, the hyperparameter a is set to α=0.7 to add the additional guidance while preserving the content of the original input Sₖ after the data augmentation.

According to some embodiments, four guidance inputs G_{obj} are used during training time to train mask generation model 1360. First, in the absence of additional user inputs, G_{obj}=0^{H×W} is used which prompts the diffusion model to suggest fine-grained masks for the object insertion at diverse positions and scales. For example, the first embodiment is illustrated and described with reference to FIG. 3. Second, the diffusion model receives a bounding box as additional guidance during training time. For example, G_{obj} is set as a binary mask corresponding to a ground-truth object mask Aₖ₊₁. Third, the diffusion model receives a coarse spatial input as additional guidance during training time. For example, a user may provide a coarse spatial location. Then, the diffusion model learns to infer the best placement of the object around the suggested region. During training, the additional guidance G_{obj} is set to a coarse Gaussian blob centered at the ground-truth object mask Aₖ₊₁. Fourth, the diffusion model receives a user scribble as additional guidance during training time. For example, the additional guidance G_{obj} is set to a dilated version of the fine-grained object mask Aₖ₊₁.

According to some embodiments, mask generation model 1360 is trained to iteratively generate image masks depicting a plurality of objects. For example, mask generation model 1360 is trained for multiple object insertions or trained to design a fine-grained layout from scratch with a large number (e.g., more than ten) of scene elements. In some cases, the final scene (or image mask) is consistent with the final scene context description T_{context}.

According to some embodiments, the training component trains a visual-instruction tuning-based planning model (or a global planning model) which learns to plan the positioning of different scene elements over long sequences based on an input semantic layout S₁. For example, using the object description T_{obj} and a final scene context T_{context}, the global planning model generates one or more bounding box suggestions for object insertion. Mask generation model 1360 uses the predictions generated by the global planning model as coarse spatial guidance input G_{obj} to generate fine-grained mask suggestions for the next object. This process is repeated iteratively until all objects are added to the scene.

According to some aspects, the global planning model is trained in two stages. First, the global planning model is trained for feature alignment. For example, the global planning model is trained in a semantic space. In some cases, a model such as a pre-trained LLaVA model is fine-tuned to learn the semantic inputs. For example, using the intermediate layer semantic map Sₖ, the projection matrix W of the LLaVA model to predict the semantic object labels {O₁, O₂, . . . Oₖ} described in the current scene as:

$${ℒ}_{align} ( W ) = {ℒ}_{CE} ( 〈 {O}_{1} , {O}_{2} , … {O}_{k} 〉 , ℋ ( {S}_{k} ) ) . \qquad ( 8 )$$

During the second training stage, the visual encoder weights of the LLaVA model are kept frozen, and the projection matrix W and LLM weights Φ are fine-tuned for global object planning. For example, using the intermediate layer semantic map Sₖ, the training component calculates the bounding box coordinates Bₖ₊₁={xₘᵢₙ, yₘᵢₙ, xₘₐₓ, yₘₐₓ} for the next object T_{obj}=Oₖ₊₁ with ground-truth object mask Aₖ₊₁. The LLaVA model can be trained as:

$${ℒ}_{instruct} ( W , Φ ) = {ℒ}_{CE} ( {B}_{k + 1} , ℋ ( {S}_{k} , {T}_{obj} , C ) ) , \qquad ( 9 )$$

where C represents the caption for the final scene, for example, obtained using the ground-truth image I and provide the model context for placing different scene elements in the image.

Caption component 1335 is an example of, or includes aspects of, the corresponding element described with reference to FIG. 9. Mask generation model 1360 is an example of, or includes aspects of, the corresponding element described with reference to FIGS. 3, 9, and 10. Prediction mask 1365 is an example of, or includes aspects of, the image mask described with reference to FIGS. 3-5, and 10.

FIG. 14 shows an example of a computing device 1400 according to aspects of the present disclosure. The example shown includes computing device 1400, processor 1405, memory subsystem 1410, communication interface 1415, I/O interface 1420, user interface component 1425, and channel 1430.

In some embodiments, computing device 1400 is an example of, or includes aspects of, the image processing apparatus described with reference to FIGS. 1 and 9. In some embodiments, computing device 1400 includes processor 1405 that can execute instructions stored in memory subsystem 1410 to obtain an input prompt and a layout mask, where the input prompt includes a first element and the layout mask includes a second element and to generate an image mask based on the input prompt and the layout mask, where the image mask indicates a location of the first element and a location of the second element.

According to some embodiments, processor 1405 includes one or more processors. In some cases, processor 1405 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1405 is configured to operate a memory array using a memory controller. In other cases, a memory controller is integrated into processor 1405. In some cases, processor 1405 is configured to execute computer-readable instructions stored in a memory to perform various functions. In some embodiments, processor 1405 includes special-purpose components for modem processing, baseband processing, digital signal processing, or transmission processing. Processor 1405 is an example of, or includes aspects of, the processor unit described with reference to FIG. 9.

According to some embodiments, memory subsystem 1410 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1410 is an example of, or includes aspects of, the memory unit described with reference to FIG. 9.

According to some embodiments, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1415.

According to some embodiments, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or hardware components controlled by the I/O controller.

According to some embodiments, user interface component 1425 enables a user to interact with computing device 1400. In some cases, user interface component 1425 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over existing technology (e.g., conventional image generation models). Example experiments demonstrate that the image processing apparatus based on the present disclosure outperforms conventional image generation models. Details on the example use cases based on embodiments of the present disclosure are described with reference to FIGS. 3-7.

The description and drawings described herein represent example configurations and do not represent all the implementations within the scope of the claims. For example, the operations and steps may be rearranged, combined, or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not necessarily limited to the examples and designs described herein but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA), or other programmable logic device, discrete gate or transistor logic, discrete hardware components, or any combination thereof. A general-purpose processor may be a microprocessor, a conventional processor, a controller, a microcontroller, or a state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt and a layout mask, wherein the input prompt describes a first element, and the layout mask includes a second element;
generating, using a mask generation model, an image mask based on the input prompt and the layout mask, wherein the image mask includes a first region corresponding to the first element and a second region corresponding to the second element; and
providing the image mask to an image generation model for generating a synthetic image, wherein the synthetic image depicts the first element in the first region and the second element in the second region.

2. The method of claim 1, wherein:
the first element comprises a foreground element and the second element comprises a background element.

3. The method of claim 1, wherein obtaining the layout mask comprises:
obtaining a reference image; and
segmenting the reference image to obtain the layout mask.

4. The method of claim 1, further comprising:
creating a training set for training a machine learning model, wherein the training set includes the image mask.

5. The method of claim 4, further comprising:
obtaining a noise map; and
denoising the noise map based on the input prompt.

6. The method of claim 1, wherein:
the input prompt describes a relation between the first element and the second element.

7. The method of claim 1, further comprising:
obtaining a bounding mask indicating a target region for the first element, wherein the image mask is generated based on the bounding mask and the region of the first element corresponds to the target region.

8. The method of claim 1, wherein:
the image mask includes a first layer indicating the first region and a second layer indicating the second region.

9. The method of claim 1, wherein:
the image mask includes a first color indicating the first region and a second color indicating the second region.

10. The method of claim 1, further comprising:
generating, using the mask generation model, a subsequent image mask based on the image mask, wherein the subsequent image mask indicates a location of a third element.

11. The method of claim 1, wherein:
the mask generation model is trained using a training set that includes an input layout mask and a ground-truth image mask.

12. A method comprising:
obtaining a training set including an input prompt, an input layout mask, and a ground-truth image mask, wherein the input prompt includes a first element, the input layout mask includes a second element, and the ground-truth image mask includes the first element and the second element; and
training, using the training set, a mask generation model to generate an image mask based on the input layout mask and the input prompt, wherein the image mask indicates a location of the first element and a location of the second element.

13. The method of claim 12, wherein obtaining the training set comprises:
segmenting a training image to obtain the ground-truth image mask; and
removing the first element from the ground-truth image mask to obtain the input layout mask.

14. The method of claim 13, wherein obtaining the training set comprises:
generating the input prompt based on the training image.

15. The method of claim 12, wherein training the mask generation model comprises:
computing a diffusion loss based on the ground-truth image mask; and
updating parameters of the mask generation model based on the diffusion loss.

16. The method of claim 12, further comprising:
initializing the mask generation model based on a pre-trained image generation model.

17. An apparatus comprising:
at least one processor;
at least one memory storing instructions executable by the at least one processor; and
a mask generation model comprising parameters stored in the at least one memory and trained to generate an image mask based on an input prompt and a layout mask, wherein the input prompt includes a first element, the layout mask includes a second element, and the image mask indicates a first region corresponding to the first element and a second region corresponding to the second element.

18. The apparatus of claim 17, further comprising:
a segmentation model configured to segment a reference image to obtain the layout mask.

19. The apparatus of claim 17, further comprising:
an image generation model configured to generate a synthetic image based on the image mask.

20. The apparatus of claim 17, wherein:
the mask generation model comprises a diffusion model.
